(19) United States
(12) Patent Application Publication
(10) Pub. No.: US 2009/0136720 A1
(43) Pub. Date: May 28, 2009

(54) Azo Compound, Ink Composition, Recording Method and Colored Article

(76) Inventors: Takahiko Matsui, Tokyo (JP); Ryoutarou Morita, Tokyo (JP); Yoshiyuki Dejima, Tokyo (JP)

Correspondence Address: Nields, Lemack & Frame, LLC, 176 E. Main Street, Suite #5, Westborough, MA, 01581, US

(21) Appl. No.: 11/991,941

(22) PCT Filed: Sep. 13, 2006
(86) PCT No.: PCT/JP2006/318137

§ 371 Date: Mar. 12, 2008

(51) Int. Cl. B32B 3/10; C09B 46/00; B05D 5/06

(52) U.S. Cl. 428/195.1; 534/616; 427/256

(57) ABSTRACT

The present invention relates to an azo compound represented by the following formula (1)

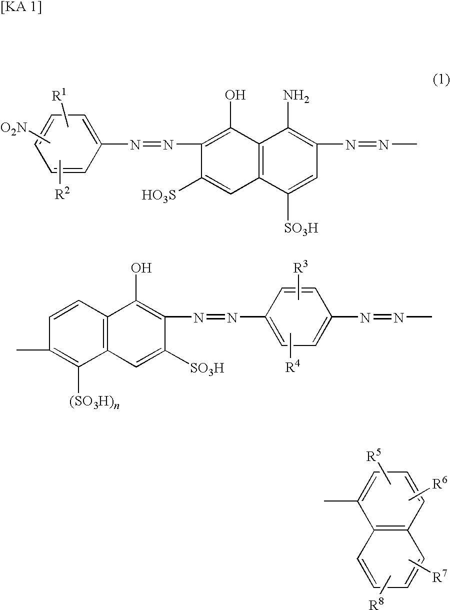

(wherein, each of R¹ and R² independently represents a hydrogen atom, a halogen atom, a cyano group, a carboxy group, a sulfo group, a sulfamoyl group, an N-alkylaminosulfonyl group, an N-phenylaminosulfonyl group and the like; each of R³, R⁴, R⁵, R⁶, R⁷ and R⁸ independently represents a hydrogen atom, a halogen atom, a hydroxy group, a cyano group, a carboxy group, a sulfo group, a sulfamoyl group, an N-alkylaminosulfonyl group, an N-phenylaminosulfonyl group and the like; and n represents 0 or 1, respectively)
or a salt thereof, an ink composition containing the same, a recording method and a colored article; the ink composition containing said azo compound has superior storage stability for a long period of time; and articles recorded with said ink composition has superior light fastness and ozone gas fastness.

### TECHNICAL FIELD

The present invention relates to a novel azo compound or a salt thereof, an ink composition containing these, and an article colored therewith.

### BACKGROUND ART

The recording method by means of an ink jet printer which is one of typical methods among various color recording methods is that ink droplets are generated and deposited onto various record-receiving materials (such as paper, film and cloth) to perform recording. This method has been rapidly prevailing lately and is expected to continue growing remarkably in the future because of such features as quietness with less noise generation due to no direct contact of a recording head with a record-receiving material and as easiness in downsizing and speedup. Conventionally, as an ink for fountain pens or felt-tip pens and an ink for inkjet recording, water-based inks dissolving a water-soluble dye in an aqueous medium have been used, and in these water-soluble inks, a water-soluble organic solvent is generally added to prevent ink from clogging at a pen tip or an inkjet nozzle. And these conventional inks are required to provide recorded images with sufficient density, not to clog at a pen tip or a discharge nozzle, to dry quickly on record-receiving materials, to bleed less, to have good storage stability, and the like. Also water-soluble dyes are required to have high solubility particularly in water and high solubility in a water-soluble organic solvent to be added to ink. In addition, formed images are required to have image fastness such as water fastness, light fastness, ozone gas fastness and moisture fastness.

Ozone gas fastness among them means durability against phenomenon that ozone gas and the like having oxidizing property in the air react with a dye on a recording paper to incur discoloration or fading of a printed image. Although oxidizing gas having this kind of action includes NOx, SOx and the like besides ozone gas, ozone gas among these oxidizing gases is regarded as a main causative substance to further promote the phenomenon of discoloration or fading of an inkjet recorded image. For an ink-receiving layer provided at the surface of a photo-image quality inkjet paper, so as to dry the ink faster and decrease bleed in high quality images, materials such as porous white inorganic substances and the like are often used, and on such recording papers, discoloration or fading in color caused by ozone gas occurs noticeably. As the phenomenon of discoloration or fading caused by oxidizing gas are characteristics of inkjet images, improvement of ozone gas fastness is one of the most important problems in the inkjet recording method.

To extend the application field of a printing method using ink in the future, ink compositions to be used for inkjet recording and colored articles colored thereby are strongly required to exhibit further improved light fastness, ozone gas fastness, moisture fastness and water fastness.

Among inks with various hues prepared from various dyes, a black ink is an important one to be used for both of mono color and full color images. A lot of dyes for black ink have been proposed so far, but any product fully meeting the requirements of the marketplace has not been provided yet. Many coloring matters proposed are azo coloring matters, and the disazo coloring matter of C.I.Food Black 2 and the like among them has such problems that the optical density of printed images is low, water fastness and moisture fastness are not good, and that gas fastness is not sufficient. A polyazo coloring matter with extension of the conjugate system generally has such problems that the water-solubility is low, a bronzing phenomenon of which a recorded image partially has metallic luster tends to take place, and that gas fastness is not sufficient. In addition, a metal-containing azo coloring matter similarly proposed in large numbers has such problems that metal ion contained in them is not preferable in view of safety to creatures and environment, and that ozone gas fastness is extremely poor.

As a compound (coloring matter) for black ink for inkjet which is improved on ozone gas fastness which has recently been one of the most significant problems, for example, the compounds described in Patent Literature 1 are cited. The ozone gas fastness of these compounds, however, does not sufficiently satisfy the requirements of the market. In addition, Patent Literatures 2 and 3 describe a trisazo compound, as an compound (coloring matter) for black ink, where a residue group of gamma acid (6-amino-4-naphthol-2-sulfonic acid) or J acid (7-amino-4-naphthol-2-sulfonic acid) is bonded on the side of the amino group of H acid (4-amino-5-naphthol-2,7-disulfonic acid) or K acid (4-amino-5-naphthol-1,7-disulfonic acid) by azo-coupling and a phenyl group or a naphthyl derivative group is bonded on the side of the hydroxy group by azo-coupling, but they do not satisfy sufficiently the requirements of the marketplace, particularly requirements on ozone gas fastness.

### Patent Literature 1: JP 2003-183545 A

### Patent Literature 2: JP 1987-109872 A

### Patent Literature 3: JP 2003-201412 A

### DISCLOSURE OF THE INVENTION

### Problems to be Solved by the Invention

An object of the present invention is to provide a coloring matter compound for black ink which has high solubility in medium whose main component is water, which has stability in long-term storage of high concentrated aqueous solution and ink, which exhibits extremely high density of a printed image, which does not generate bronzing on printed images even in the case of printing with a high concentrated solution on photo-image quality inkjet paper, which gives recorded images of black color superior in fastnesses of the printed image, especially ozone gas fastness, and which is synthesized easily and inexpensively, and an ink composition thereof.

### Means of Solving the Problems

The inventors of the present invention intensively studied a way to solve the above problems and have found that a particular tetrakis-azo compound can solve the above problems and completed the present invention. That is, the present invention relates to;

(1) An azo compound represented by the following Formula (1)

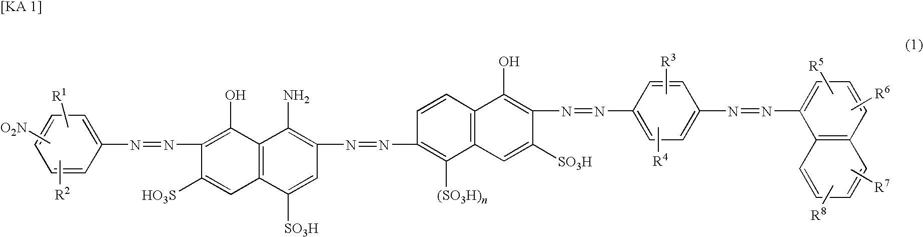

(wherein, each of R¹, and R² independently represents a hydrogen atom, a halogen atom, a cyano group, a carboxy group, a sulfo group, a sulfamoyl group, an N-alkylaminosulfonyl group, an N-phenylaminosulfonyl group, a (C1 to C4) alkylsulfonyl group which may be substituted by a hydroxy group, a phosphono group, a nitro group, an acyl group, a ureide group, a (C1 to C4) alkyl group (which may be substituted by a group selected from the group consisting of a hydroxy group and a (C1 to C4) alkoxy group), a (C1 to C4) alkoxy group (which may be substituted by a group selected from the group consisting of a hydroxy group, a (C1 to C4) alkoxy group, a sulfo group and a carboxy group), an acylamino group, an alkylsulfonylamino group or a phenylsulfonylamino group (the phenyl group may be substituted by a group selected from the group consisting of a halogen atom, an alkyl group and a nitro group),
each of R³, R⁴, R⁵, R⁶, R⁷ and R⁸ independently represents a hydrogen atom, a halogen atom, a hydroxy group, a cyano group, a carboxy group, a sulfo group, a sulfamoyl group, an N-alkylaminosulfonyl group, an N-phenylaminosulfonyl group, a (C1 to C4) alkylsulfonyl group which may be substituted by a hydroxy group, a phosphono group, a nitro group, an acyl group, a ureide group, a (C1 to C4) alkyl group (which may be substituted by a hydroxy group or a (C1 to C4) alkoxy group), a (C1 to C4) alkoxy group (which may be substituted by a group selected from the group consisting of a hydroxy group, a (C1 to C4) alkoxy group, a sulfo group and a carboxy group), an acylamino group, an alkylsulfonylamino group or a phenylsulfonylamino group (the phenyl group may be substituted by a group selected from the group consisting of a halogen atom, an alkyl group and a nitro group), and
n represents 0 or 1, respectively)
or a salt thereof,
(2) The azo compound or the salt thereof according to the above (1), wherein R¹ is a sulfo group or a carboxy group, the substitution position of the nitro group is the para-position to the azo group when the substitution position of R¹ is the ortho-position to the azo group, the substitution position of the nitro group is the ortho-position to the azo group when the substitution position of R¹ is the para-position to the azo group, and R² is a hydrogen atom,
(3) The azo compound or the salt thereof according to the above (1), wherein R¹ is a sulfo group and its substitution position is the ortho-position to the azo group, the substitution position of the nitro group is the para-position to the azo group, R² is a hydrogen atom, and n is 1,
(4) The azo compound or the salt thereof according to any one of the above (1) to (3), wherein R⁶ and R⁷ are sulfo groups,
(5) The azo compound or the salt thereof according to any one of the above (1) to
(4), wherein R⁵ is a hydrogen atom, R⁶ and R⁷ are sulfo groups, and R⁸ is a hydroxy group,
(6) The azo compound or the salt thereof according to the above (1), wherein R¹ is a sulfo group or a carboxy group, R² is a hydrogen atom, R³ is a group selected from the group consisting of a 3-sulfopropoxy group, a carboxymethoxy group, a sulfo group, and a 2-hydroxyethoxy group, R⁴ is a group selected from the group consisting of a methyl group, an acetylamino group, a hydrogen atom, a 2-hydroxyethoxy group and a sulfo group, R⁵ is a group selected from the group consisting of a hydrogen atom, a toluenesulfonyl amino group and a sulfo group, R⁷ is a hydrogen atom or a sulfo group, each of R⁶ and R⁸ independently is a sulfo group or a hydroxy group, and n is 1,
(7) The azo compound or the salt thereof according to the above (1), wherein R¹ is a sulfo group and its substitution position is the ortho-position to the azo group, the substitution position of the nitro group is the para-position to the azo group, R² is a hydrogen atom, R⁵ is a hydrogen atom, R⁶ and R⁷ are sulfo groups, R⁸ is a hydroxy group and its substitution position is the peri-position to the azo group, and n is 1,
(8) The azo compound or the salt thereof according to the above (1), wherein R¹ is a sulfo group and its substitution position is the ortho-position to the azo group, the substitution position of the nitro group is the para-position to the azo group, R² is a hydrogen atom, R³ is a 3-sulfopropoxy group, R⁴ is a methyl group, R⁵ is a hydrogen atom, R⁶ and R⁷ are sulfo groups, R⁸ is a hydroxy group and its substitution position is the peri-position to the azo group, and n is 1,
(9) An ink composition characterized by comprising at least one of the azo compounds or the salts thereof according to any one of the above (1) to (8),
(10) An inkjet print recording method characterized by using the ink composition according to the above (9),
(11) The inkjet print recording method according to the above (10), wherein a record-receiving material in the inkjet print recording method is an information transmission sheet,
(12) The inkjet print recording method according to the above (11), wherein the information transmission sheet contains a porous white inorganic substance,
(13) An ink jet printer loading a container containing the ink composition according to the above (9),
(14) A colored article colored with the azo compound or the salt thereof according to any one of the above (1) to (8),
(15) The azo compound or the salt thereof according to the above (1) to (3), wherein R³ is a hydroxy (C1 to C4) alkoxy group, a sulfo (C1 to C4) alkoxy group, a carboxy (C1 to C4) alkoxy group or a sulfo group, R⁴ is a hydrogen atom, a hydroxy (C1 to C4) alkoxy group, a sulfo group, (C1 to C4) alkyl group or a (C1 to C4) acylamino group, R⁵ is a hydrogen atom or a phenylsulfonylamino group substituted by a (C1 to C4) alkyl group, R⁶ and R⁷ are sulfo groups, and R⁸ is a hydrogen atom, a hydroxy group or a sulfo group.

### EFFECT OF THE INVENTION

The azo compound of the present invention or the salt thereof (hereinafter, the both are collectively referred to as the azo compound) is excellent in water-solubility, so filtration property by a membrane filter in the production process of the ink composition is good and its recording liquid is excellent in stability in its storage and discharge stability. In addition, the ink composition of the present invention containing this azo compound generates no crystal precipitation and exhibits no change in physical property or color, nor the like, after storage for a long period of time. Accordingly, it has good storage stability. Further, an ink composition containing the azo compound of the present invention can be suitably used for inkjet recording and writing tools, when recording is performed therewith on plain paper and inkjet paper, the printing density of recorded images is extremely high and no bronzing is generated on the images which is even printed with its high concentration solution; and it is also excellent in fastnesses, particularly ozone gas fastness. Using the ink composition of the present invention together with an ink composition with dyes of magenta, cyan and yellow enables full color inkjet recording excellent in various fastnesses and storage. As mentioned above, the ink composition of the present invention is remarkably useful as a black ink for inkjet recording.

### BEST MODE FOR CARRYING OUT THE INVENTION

Hereinafter, the present invention will be explained specifically.

In the present invention, the terms “alkyl” and “acyl” are not particularly limited, but typically the alkyl group is preferably “(C1 to C4) alkyl” and the acyl is preferably “(C2 to C5) aliphatic acyl” or “(C7˜C11) aromatic acyl”. In addition, the term “halogen” is not limited, but typically, preferably “chlorine atom” or “bromine atom”.

For R¹ to R⁸, examples of the N-alkylaminosulfonyl group include, for example, N—(C1 to C4)alkylaminosulfonyl groups such as N-methylaminosulfonyl, N-ethylaminosulfonyl, N-(n-propyl)aminosulfonyl, N-(i-propyl)aminosulfonyl, N-(n-butyl)aminosulfonyl, N-(i-butyl)aminosulfonyl, N-(sec-butyl)aminosulfonyl, N-(t-butyl)aminosulfonyl, N,N-dimethylaminosulfonyl, N,N-diethylaminosulfonyl, N,N-di(n-propyl)aminosulfonyl, N,N-di(n-butyl)aminosulfonyl or the like.

For R¹ to R⁸, examples of the (C1 to C4) alkylsulfonyl group which may be substituted by a hydroxy group include, for example, methylsulfonyl, ethylsulfonyl, propylsulfonyl, butylsulfonyl, hydroxyethylsulfonyl, 2-hydroxypropylsulfonyl and the like.

For R¹ to R⁸, examples of the acyl group include, for example, acetyl, propionyl, butyryl, isobutyryl, benzoyl, naphthoyl and the like, and a (C2˜C5) aliphatic acyl group or (C7˜C11)aromatic acyl is preferable.

For R¹ to R⁸, examples of the (C1 to C4) alkyl group which may be substituted by a hydroxy group or a (C1 to C4) alkoxy group include, for example, methyl, ethyl, n-propyl, isopropyl, n-butyl, isobutyl, sec-butyl, tert-butyl, 2-hydroxyethyl, 2-hydroxypropyl, 3-hydroxypropyl, methoxyethyl, 2-ethoxyethyl, n-propoxyethyl, isopropoxyethyl, n-butoxyethyl, methoxypropyl, ethoxypropyl, n-propoxypropyl, isopropoxybutyl, n-propoxybutyl, n-butoxybutyl and the like.

For R¹ to R⁸, examples of the (C1 to C4) alkoxy group which may be substituted by a group selected from the group consisting of a hydroxy group, a (C1 to C4) alkoxy group, a sulfo group and a carboxy group include, for example, methoxy, ethoxy, n-propoxy, isopropoxy, n-butoxy, sec-butoxy, tert-butoxy, 2-hydroxyethoxy, 2-hydroxypropoxy, 3-hydroxypropoxy, methoxyethoxy, ethoxyethoxy, n-propoxyethoxy, isopropoxyethoxy, n-butoxyethoxy, methoxypropoxy, ethoxypropoxy, n-propoxypropoxy, isopropoxybutoxy, n-propoxybutoxy, 2-hydroxyethoxyethoxy, carboxymethoxy, 2-carboxyethoxy, 3-carboxypropoxy, 3-sulfopropoxy, 4-sulfobutoxy and the like, a (C1 to C4) alkoxy group substituted by a group selected from the group consisting of a hydroxy group, a sulfo group and a carboxy group are preferable and a sulfo (C1 to C4) alkoxy group is more preferable.

For R¹ to R⁸, examples of the acylamino group include, for example, acetylamino, propionylamino, butyrylamino, isobutyrylamino, benzoylamino, naphthoylamino and the like.

For R¹ to R⁸, examples of the alkylsulfonylamino group include, for example, methylsulfonylamino, ethylsulfonylamino, propylsulfonylamino, butylsulfonylamino and the like.

For R¹ to R⁸, examples of the phenylsulfonylamino group which may be substituted by a group selected from the group consisting of a halogen atom, an alkyl group and a nitro group include, for example, benzenesulfonylamino, toluenesulfonylamino, chlorobenzenesulfonylamino, nitrobenzenesulfonylamino and the like, and toluenesulfonylamino is more preferable.

Each of preferable R¹ and R² in the formula (1) is independently a hydrogen atom, a chlorine atom, a bromine atom, cyano, carboxy, sulfo, sulfamoyl, N-methylaminosulfonyl, N-phenylaminosulfonyl, methylsulfonyl, hydroxyethylsulfonyl, phosphono, nitro, acetyl, benzoyl, ureide, methyl, methoxy, ethyl, ethoxy, propyl, propoxy, 2-hydroxyethoxy, 2-methoxyethoxy, 2-ethoxyethoxy, 3-sulfopropoxy, 4-sulfobutoxy, carboxymethoxy, 2-carboxyethoxy, acetylamino, benzoylamino and the like, more preferably a hydrogen atom, a chlorine atom, cyano, sulfamoyl, acetyl, methylsulfonyl, hydroxyethylsulfonyl, nitro, carboxy or sulfo, and further preferably a hydrogen atom, carboxy or sulfo. Further preferable R¹ is carboxy or sulfo and sulfo is particularly preferable. For R², a hydrogen atom is particularly preferable. For substitution positions, it is preferable that the substitution position of the nitro group is the para-position to the azo group when the substitution position of R¹ is the ortho-position to the azo group, and the substitution position of the nitro group is the ortho-position to the azo group when the substitution position of R¹ is the para-position to the azo group.

The phenyl group substituted by R¹ and R² in the formula (1) is preferably p-nitro-o-sulfophenyl, p-sulfo-o-nitrophenyl or p-nitro-o-carboxyphenyl, the former two are more preferable, and p-nitro-o-sulfophenyl is most preferable.

Each of preferable R³ and R⁴ is independently a hydrogen atom, a chlorine atom, hydroxy, cyano, carboxy, sulfo, sulfamoyl, N-methylaminosulfonyl, N-phenylaminosulfonyl, methylsulfonyl, hydroxyethylsulfonyl, nitro, acetyl, benzoyl, ureide, methyl, methoxy, ethyl, ethoxy, propyl, propoxy, 2-hydroxyethoxy, 2-methoxyethoxy, 2-ethoxyethoxy, 3-sulfopropoxy, 4-sulfobutoxy, carboxymethoxy, 2-carboxyethoxy, acetylamino, benzoylamino or the like, more preferably a hydrogen atom, methyl, ethyl, methoxy, ethoxy, 2-hydroxyethoxy, 3-sulfopropoxy, carboxy or sulfo, and further preferably a hydrogen atom, methyl, 3-sulfopropoxy, carboxy and sulfo. Preferable R³ includes a hydroxy (C1 to C4) alkoxy group, a carboxy (C1 to C4) alkoxy group and a sulfo group, a sulfo (C1 to C4) alkoxy group or a carboxy (C1 to C4) alkoxy group is more preferable, and a sulfo (C1 to C4) alkoxy group is most preferable. Preferable R⁴ includes a hydrogen atom, a (C1 to C4) alkyl group and a (C1 to C4) acyl group, and a (C1 to C4) alkyl group is more preferable. It is more preferable that either preferable one is combined with the other preferable one. For the substitution positions of R³ and R⁴, R³ and R⁴ are preferably substituted on the 2-position and the 5-position when the substitution position of the azo group on the left side is 1.

Preferable R⁵ to R⁸ are hydrogen atom, chlorine atom, bromine atom, hydroxy, cyano, carboxy, sulfo, sulfamoyl, N-methylaminosulfonyl, N-phenylaminosulfonyl, methylsulfonyl, hydroxyethylsulfonyl, phospho, nitro, acetyl, benzoyl, ureide, methyl, methoxy, ethyl, ethoxy, propyl, propoxy, 2-hydroxyethoxy, 2-methoxyethoxy, 2-ethoxyethoxy, 3-sulfopropoxy, 4-sulfobutoxy, carboxymethoxy, 2-carboxyethoxy, acetylamino, benzoylamino, p-methylphenylsulfonylamino and the like, more preferably hydrogen atom, hydroxy, carboxy, sulfo, sulfamoyl, hydroxyethylsulfonyl, nitro, methyl, methoxy, ethyl or ethoxy, and further preferably hydrogen atom, hydroxy, carboxy, sulfo or sulfamoyl. Preferable R⁵ includes a hydrogen atom or phenylsulfonylamino which may be substituted by a (C1 to C4) alkyl group, and more preferably a hydrogen atom. Preferable R⁶ and R⁷ include sulfo. Preferable R⁸ includes a hydrogen atom, sulfo and hydroxy, and hydroxy is more preferable. The substitution position of R⁸ is preferably the peri-position (the 8-position) to the azo group. A combination of these preferable R⁵ to R⁸ is more preferable.

The most preferable combination of R⁵ to R⁸ is that R⁵ is a hydrogen atom, R⁶ and R⁷ are sulfo, R⁸ is hydroxy, and the substitution position of R⁸ is the peri-position to the azo group.

n can be any of 0 and 1, preferably 1.

The salt of the azo compound represented by the above formula (1) is a inorganic or organic cation salt. Specific examples of the inorganic salt among them include an alkali metal salt, an alkaline earth metal salt, an ammonium salt and the like, a preferable inorganic salt is a salt of lithium, sodium and potassium, and an ammonium salt, and the organic cation salt includes, for example, a salt of the compound represented by the following formula (2), but not limited thereto.

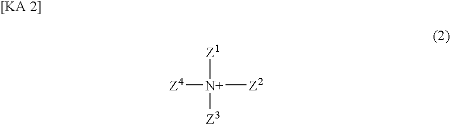

In the formula (2), each of Z¹, Z², Z³ and Z⁴ independently represents a group selected from the group consisting of a hydrogen atom, an alkyl group, a hydroxyalkyl group and a hydroxyalkoxyalkyl group.

Specific examples of the alkyl group of Z¹, Z², Z³ or Z⁴ in the formula (2) include methyl, ethyl, n-propyl, isopropyl, n-butyl, isobutyl, sec-butyl, tert-butyl and the like, specific examples of the hydroxyalkyl group include hydroxy-(C1 to C4) alkyl groups such as hydroxymethyl, hydroxyethyl, 3-hydroxypropyl, 2-hydroxypropyl, 4-hydroxybutyl, 3-hydroxybutyl and 2-hydroxybutyl, examples of the hydroxyalkoxyalkyl group include hydroxy (C1 to C4) alkoxy-(C1 to C4) alkyl groups such as hydroxyethoxymethyl, 2-hydroxyethoxyethyl, 3-hydroxyethoxypropyl, 2-hydroxyethoxypropyl, 4-hydroxyethoxybutyl, 3-hydroxyethoxybutyl and 2-hydroxyethoxybutyl, and a hydroxyethoxy-(C1 to C4) alkyl group is preferable among them. Particularly preferable is a hydrogen atom; methyl; a hydroxy-(C1 to C4) alkyl group such as hydroxymethyl, hydroxyethyl, 3-hydroxypropyl, 2-hydroxypropyl, 4-hydroxybutyl, 3-hydroxybutyl and 2-hydroxybutyl; a hydroxyethoxy-(C1 to C4) alkyl group such as hydroxyethoxymethyl, 2-hydroxyethoxyethyl, 3-hydroxyethoxypropyl, 2-hydroxyethoxypropyl, 4-hydroxyethoxybutyl, 3-hydroxyethoxybutyl and 2-hydroxyethoxybutyl. A preferable combination of these Z¹, Z², Z³ and Z⁴ is that any two of them are hydrogen atoms and/or (C1 to C4) alkyl groups and the rest two are hydroxy (C1 to C4) alkyl groups, or any one of them is a hydrogen atom and the rest three are hydroxy (C1 to C4) alkyl groups.

Specific examples of Z¹, Z², Z³ and Z⁴ in the formula (2) are shown in Table 1.

TABLE 1

| Compound No. | Z¹ | Z² | Z³ | Z⁴ |
|---|---|---|---|---|
| 1-1 | H | —C2H4OH | —C2H4OH | —C2H4OH |
| 1-2 | CH3 | —C2H4OH | —C2H4OH | —C2H40H |
| 1-3 | H | —CH2CH(OH)CH3 | —CH2CH(OH)CH3 | —CH2CH(OH)CH3 |
| 1-4 | CH3 | —CH2CH(OH)CH3 | —CH2CH(OH)CH3 | —CH2CH(OH)CH3 |
| 1-5 | H | —C2H4OH | H | —C2H4OH |
| 1-6 | CH3 | —C2H4OH | H | —C2H4OH |
| 1-7 | H | —CH2CH(OH)CH3 | H | —CH2CH(OH)CH3 |
| 1-8 | CH3 | —CH2CH(OH)CH3 | H | —CH2CH(OH)CH3 |
| 1-9 | CH3 | —C2H4OH | CH3 | —C2H4OH |
| 1-10 | CH3 | —CH2CH(OH)CH3 | CH3 | —CH2CH(OH)CH3 |

The azo compound of the present invention represented by the formula (1) can be synthesized by, for example, the following method. In this connection, the structural formulas in the processes are shown in free acid form.

A compound represented by the following formula (3)

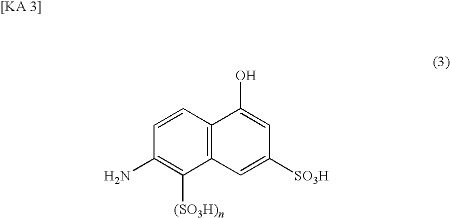

(wherein, n has the same meaning as in the formula (1))
and a p-toluenesulfonyl chloride are reacted in the presence of alkali to obtain a compound represented by the following formula (4)

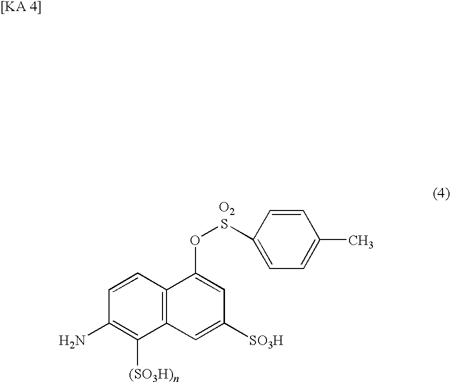

(wherein, n has the same meaning as the above).

The obtained compound of the formula (4) is diazotized in a conventional manner, and then the diazotized compound is subjected to coupling reaction with 4-amino-5-naphthol-1,7-disulfonic acid under the acid condition to obtain a compound represented by the following formula (5)

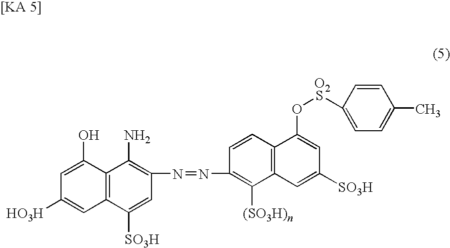

(wherein, n has the same meaning as the above).
The obtained compound of the formula (5) is subjected to coupling reaction with a compound where a compound represented by the following formula (6)

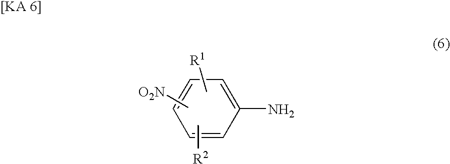

(wherein, R¹ and R² have the same meanings as in the formula (1))
has been diazotized in a conventional manner, to obtain a compound represented by the following formula (7)

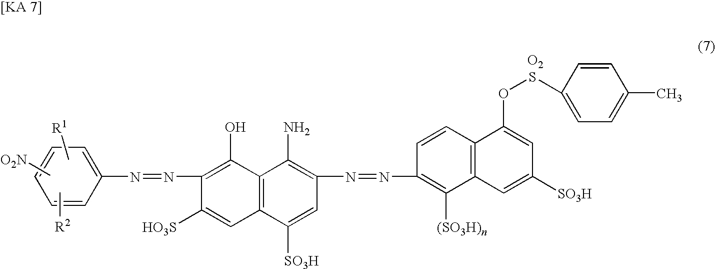

(wherein, R¹, R² and n have the same meanings as the above).
The obtained compound of the formula (7) is hydrolyzed under the alkaline condition to obtain a compound represented by the following formula (8)

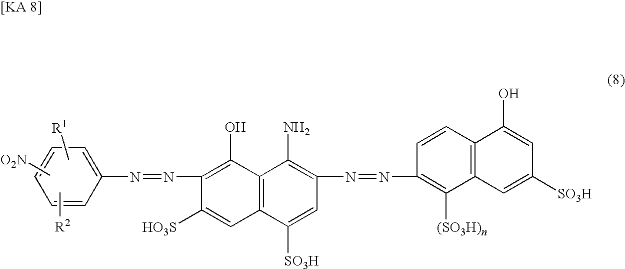

(wherein, R¹, R² and n have the same meanings as the above).
Subsequently, a compound represented by the following formula (9)

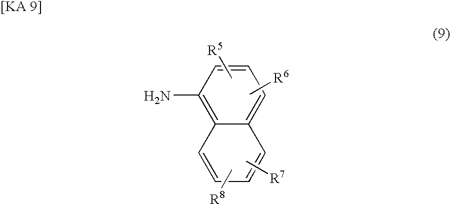

(wherein R⁵ to R⁸ have the same meanings as in the formula (1)) is diazotized in the conventional manner, and the diazotized compound and a compound represented by the following formula (10)

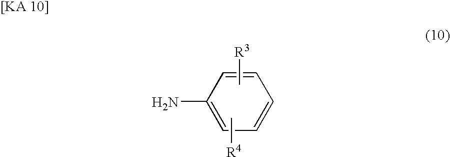

(wherein, R³ and R⁴ have the same meanings as in the formula (1)) are subjected to coupling reaction to obtain a monoazo compound represented by the following formula (11)

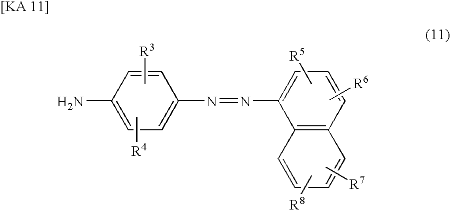

(wherein, R³ to R⁸ have the same meanings as the above). The obtained compound of the formula (11) is diazotized in the conventional manner, and said diazotized compound and the compound of the formula (8) obtained above are subjected to coupling reaction to obtain an azo compound of the present invention represented by the formula (1) or a salt thereof.

Preferred specific examples of the compound of the present invention represented by the formula (1) include, not limited thereto, the compounds represented by the following formulas. In the tables, the sulfo group and the carboxy group are shown in free acid form.

### [Table 2-1]

TABLE 2-1

| Comp. | |
|---|---|
| No. | Structural Formula |
| 1 | 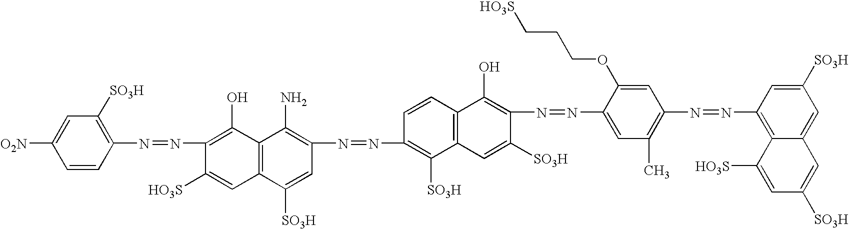 |
| 2 | 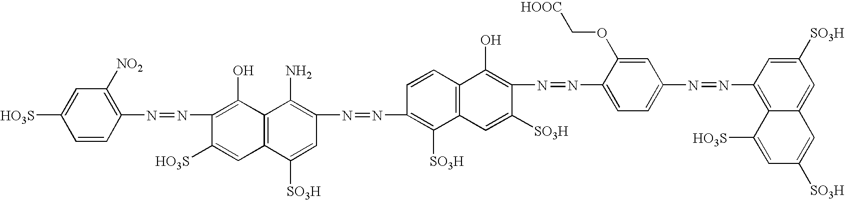 |
| 3 | 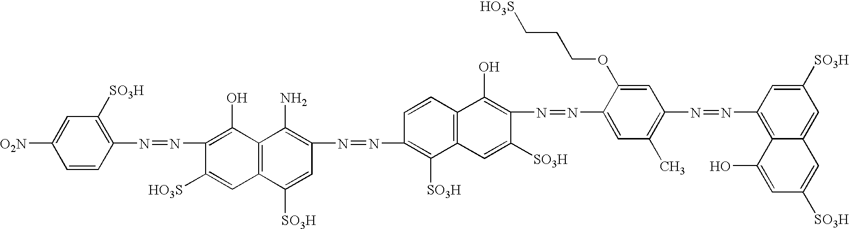 |
| 4 | 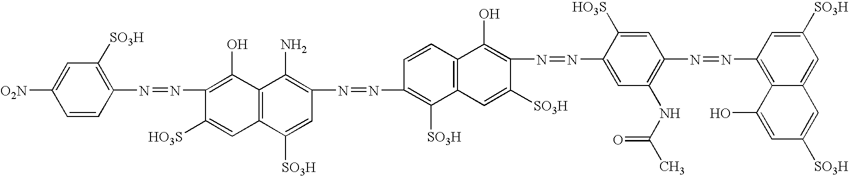 |
| 5 | 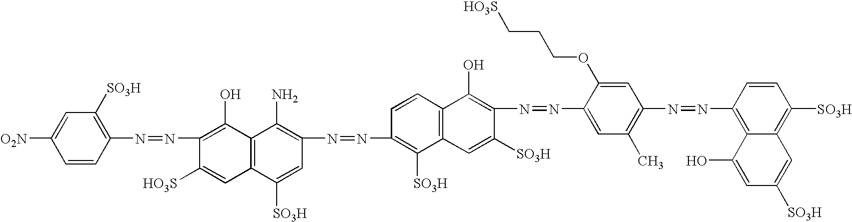 |
| 6 | 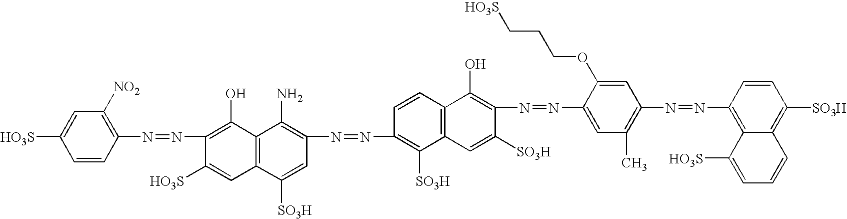 |

### [Table 2-2]

TABLE 2-2

| Comp. | |
|---|---|
| No. | Structural Formula |
| 7 | 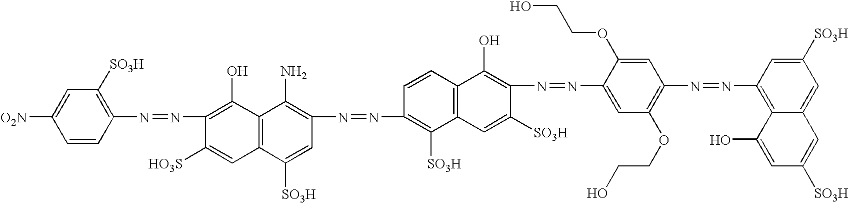 |
| 8 | 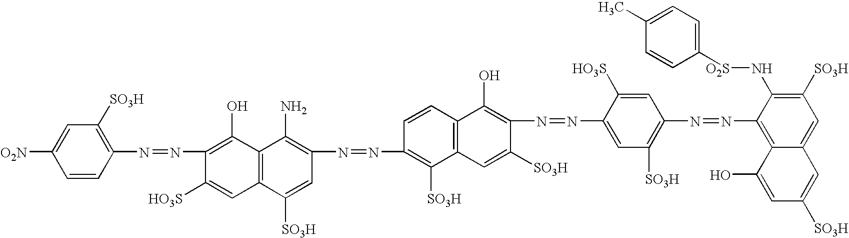 |
| 9 | 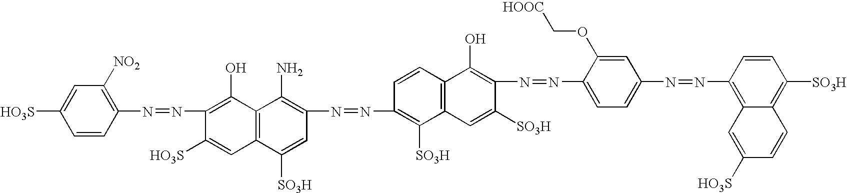 |
| 10 | 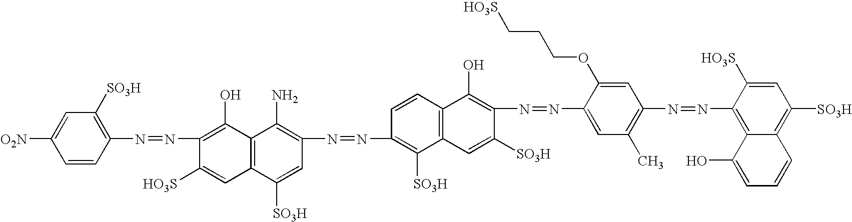 |
| 11 | 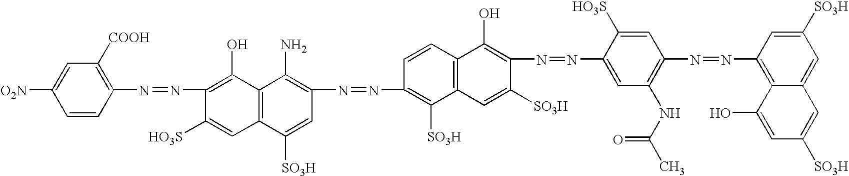 |

The reaction of the compound of the above formula (3) with a p-toluenesulphonyl chloride is carried out by a known method per se, advantageously in water or an aqueous organic medium, for example, at a temperature of 20 to 100° C., preferably 30 to 80° C., and at a pH value of from neutral to alkaline. The reaction is preferably carried out at a pH value of from neutral to weakly alkaline, for example, pH 7 to 10. Adjustment of this pH value is carried out by addition of a base. As the base, for example, alkali metal hydroxides such as lithium hydroxide and sodium hydroxide, alkali metal carbonates such as lithium carbonate, sodium carbonate and potassium carbonate, acetate salt such as sodium acetate, or the like can be used. The compound of the formula (3) and the p-toluenesulfonyl chloride are used in nearly stoichiometric amounts.

The diazotization of the compound of the formula (4) is carried out by a known method per se. It is carried out, for example, in an inorganic acid medium, for example, at a temperature of −5 to 30° C., preferably 5 to 15° C., using a nitrite salt, for example, an alkali metal nitrite such as sodium nitrite. The coupling of the diazotized compound of the compound of the formula (4) and 4-amino-5-naphthol-1,7-disulfonic acid is carried out under the known conditions per se. For example, said coupling reaction is advantageously carried out in water or an aqueous organic medium, for example, at a temperature of −5 to 30° C., preferably 5 to 25° C., and at a pH value of from acidic to neutral, preferably from acidic to weakly acidic, for example, pH 1 to 4. Generally, as acidity is enhanced in the coupling reaction system, the pH value is preferably maintained by addition of a base, preferably at from acidic to weakly acidic, for example, at pH 1 to 4, in the coupling reaction system. As the base, for example, alkali metal hydroxides such as lithium hydroxide and sodium hydroxide; alkali metal carbonates such as lithium carbonate, sodium carbonate and potassium carbonate; acetate salt such as sodium acetate; ammonia; organic amine, or the like can be used. The compound of the formula (4) and 4-amino-5-naphthol-1,7-disulfonic acid are used in nearly stoichiometric amounts.

The diazotization of the compound of the formula (6) is also carried out by a known method per se, for example, in an inorganic acid medium, for example, at a temperature of −5 to 30° C., preferably 0 to 15° C., using a nitrite salt, for example, an alkali metal nitrite such as sodium nitrite. The coupling of the diazotized compound of the compound of the formula (6) with the compound of the formula (5) is also carried out under the known conditions per se. It is advantageously carried out in water or an aqueous organic medium, for example, at a temperature of −5 to 50° C., preferably 10 to 40° C., and at a pH value of from weakly acidic to alkaline, for example, at pH 5 to 10. The adjustment of the pH value is carried out by addition of a base. As the base, for example, alkali metal hydroxides such as lithium hydroxide and sodium hydroxide; alkali metal carbonates such as lithium carbonate, sodium carbonate and potassium carbonate; acetate salt such as sodium acetate; ammonia; organic amine; or the like can be used. The compounds of the formulas (5) and (6) are used in nearly stoichiometric amounts.

The production of the compound of the formula (8) by hydrolyzation of the compound of the formula (7) is also carried out by a known method per se. Advantageous is a method of heating in an aqueous alkaline medium, where it is carried out, for example, by addition of a sodium hydroxide or a potassium hydroxide to a solution containing the compound of the formula (7) to adjust the pH to no less than 9.5, and then by heating, for example, to a temperature of 20 to 150° C., preferably to a temperature of 30 to 100° C. At this time, the pH value of the reaction solution is preferably maintained at 9.5 to 11.5. This adjustment of the pH value is carried out by addition of a base. The bases described above can be used.

The diazotization of the compound of the formula (9) is also carried out by a known method per se. For example, said diazotization is carried out in an inorganic acid medium, for example, at a temperature of −5 to 30° C., preferably 0 to 15° C., using a nitrite salt, for example, an alkali metal nitrite such as sodium nitrite. The coupling of the diazotized compound of the compound of the formula (9) and the compound of the formula (10) is also carried out under the known conditions per se. It is advantageously carried out in water or an aqueous organic medium, for example, at a temperature of −5 to 50° C., preferably 5 to 40° C., and at a pH value of from acidic to neutral. For example, it is carried out at pH 1 to 7, and the adjustment of the pH value is carried out by addition of a base. As the base, for example, alkali metal hydroxides such as lithium hydroxide and sodium hydroxide; alkali metal carbonates such as lithium carbonate, sodium carbonate and potassium carbonate; acetate salt such as sodium acetate; ammonia; organic amine; or the like can be used. The compounds of the formulas (9) and (10) are used in nearly stoichiometric amounts.

The diazotization of the compound of the formula (11) is also carried out by a known method per se, for example, in an inorganic acid medium, for example, at a temperature of −5 to 30° C., preferably at 0 to 25° C. or at 5 to 25° C., using a nitrite salt, for example, an alkali metal nitrite such as sodium nitrite. The coupling of the diazotized compound of the compound of the formula (11) and the compound of the formula (8) is also carried out under the known conditions per se. Said coupling reaction is advantageously carried out in water or aqueous organic medium, for example, at a temperature of −5 to 50° C., preferably 10 to 40° C., and at a pH value of from weakly acidic to alkaline, preferably from weakly acidic to weakly alkaline, for example, pH 6 to 11, and preferably pH 6 to 10. The adjustment of the pH value is carried out by addition of a base. As the base, for example, alkali metal hydroxides such as lithium hydroxide and sodium hydroxide; alkali metal carbonates such as lithium carbonate, sodium carbonate and potassium carbonate; acetate salt such as sodium acetate; ammonia; organic amine; or the like can be used. The compounds of the formulas (8) and (11) are used in nearly stoichiometric amounts.

The azo compound represented by the formula (1) of the present invention can be obtained as a salt such as sodium salt or a mixture of a salt and free acid, after the coupling reaction, the adjustment of the pH of the reaction solution at neutral, and salting out by addition of a salt such as sodium chloride. The obtained compound is, if necessary, dissolved in water and crystallized, properly 1 to 3 times, by addition of alcohol (such as methanol, or 2-propanol). Inorganic salts such as metal cation chloride and/or sulfate can be removed thereby and the objective azo compound can be obtained with less content of said inorganic salt. Or, after the coupling reaction, said azo compound can be isolated in free acid form by addition of mineral acid to said reaction solution. The isolated compound can be washed with water or acidified water to remove inorganic salts. Next, thus obtained free acid form coloring matter (compound) with a low salt content can be neutralized with a desired inorganic or organic base in an aqueous medium to make a solution of a corresponding salt. Examples of the inorganic base include, for example, alkali metal hydroxides such as lithium hydroxide, sodium hydroxide and potassium hydroxide, ammonium hydroxide, or alkali metal carbonates such as lithium carbonate, sodium carbonate and potassium carbonate, and examples of the organic base include organic amine, for example, alkanolamines represented by the above formula (2) such as diethanolamine and triethanolamine, but not limited thereto.

Then, typical use of the azo compound of the present invention will be explained.

The azo compound of the present invention can be used as a black coloring matter for dyeing various articles in a conventional manner. In a typical use, said compound is dissolved in a liquid medium, preferably an aqueous medium to be used as an aqueous composition for dyeing. An aqueous composition containing said azo compound can dye materials composed of cellulose. In addition, said aqueous composition can also dye materials having a carbonamide bond. Therefore, said aqueous composition can be widely used for dyeing of leather, cloth, paper and the like. And a typical said aqueous composition includes an ink composition.

Optionally, a reaction solution containing the azo compound of the present invention represented by the above formula (1), for example, such as a reaction solution before the adjustment of the pH to 7.0 to 8.0 with 35% hydrochloric acid in Example 1 (3) described later, can be used directly for producing the above aqueous composition, particularly the ink composition. However, typically this reaction solution is firstly dried, for example, spray-dried to isolate the azo compound or subjected to salting out with inorganic salts such as sodium chloride, potassium chloride, calcium chloride and sodium sulfate, if necessary, by adjusting the pH as in Examples described later, to aciding out with mineral acid such as hydrochloric acid, sulfuric acid and nitric acid, or to acid-salting out which is a combination of salting out and aciding out described above, to isolate the azo compound of the present invention, if necessary, from which inorganic salts are removed, and then, the azo compound is used to prepare the above aqueous composition, particularly the ink composition preferably. The content of the azo compound of the present invention in said aqueous composition can vary according to a purpose and typically about 1 to 25% by weight based on the whole aqueous composition. Said aqueous composition can contain 0 to 30% by weight of a water-soluble organic solvent and about 0 to 20% by weight of other additives, and the rest is water.

Hereinafter, the ink composition as the most typical composition of said aqueous composition will be more specifically explained.

The ink composition of the present invention is a composition where typically 0.1 to 20% by weight, preferably 1 to 10% by weight, more preferably 2 to 8% by weight of the azo compound represented by the formula (1) of the present invention is contained and water is the main medium. The ink composition of the present invention may further contain, for example, 0 to 30% by weight, preferably 2 to 25% by weight of a water-soluble organic solvent and, for example, 0 to 10% by weight, preferably 0 to 7% by weight and optionally 0 to 5% by weight of ink preparation agents. Typically, a water-soluble organic solvent is typically contained at 2 to 25% by weight, preferably 5 to 20% by weight. And the pH of the ink composition is preferably pH 5 to 11 and more preferably pH 7 to 10, in terms of improving the storage stability. Further, the surface tension of the ink composition is preferably 25 to 70 mN/m and more preferably 25 to 60 mN/m. Furthermore, the viscosity of the ink composition is preferably not more than 30 mPa·s and more preferably not more than 20 mPa·s. The pH and the surface tension of the ink composition of the present invention can be accordingly adjusted with a pH adjuster and a surfactant described later.

The ink composition of the present invention is a composition where the azo compound represented by the above formula (1) is dissolved in water or a water-soluble organic solvent (a water-miscible organic solvent), and if necessary, ink preparation agents are added. When this ink composition is used as an ink for ink jet printers, as the azo compound of the present invention, it is preferable to use the azo compound which has less content of inorganic substances such as mineral salts, metal cation chloride or sulfate, and the content is, for example, about not more than 1% by weight (to the whole coloring matter) only as a guide. In order to produce the azo compound of the present invention with less content of inorganic substance, for example, desalting treatment may be conducted by applying an ordinary method such as reverse osmosis method or the above method for removing inorganic salts to a dry form or a wet cake of the azo compound of the present invention, or by a method of stirring a dry form or a wet cake of the azo compound of the present invention in a mixed solvent of alcohol such as methanol and water followed by filtration-separation and drying, or the like.

Specific examples of the water-soluble organic solvent which can be used for preparation of the above ink composition include, for example, C1 to C4 alkanol such as methanol, ethanol, propanol, isopropanol, butanol, isobutanol, secondary butanol or tertiary butanol; carboxylic acid amide such as N,N-dimethylformamide or N,N-dimethylacetamide; lactam such as 2-pyrrolidone or N-methylpyrrolidin-2-one; cyclic ureas, such as 1,3-dimethylimidazolidin-2-one or 1,3-dimethylhexahydropyrimid-2-one; ketone or keto alcohol such as acetone or methylethylketone or 2-methyl-2-hydroxypentan-4-one; cyclic ethers such as tetrahydrofuran or dioxane; polyhydric alcohol such as mono, oligo or polyalkylene glycol, or thioglycol having a (C2 to C6) alkylene unit, such as ethylene glycol, 1,2-propylene glycol, 1,3-propylene glycol, 1,2-butylene glycol, 1,4-butylene glycol or 1,6-hexylene glycol, diethylene glycol, triethylene glycol, tetraethylene glycol or dipropylene glycol, polyethylene glycol or polypropylene glycol, or thiodiglycol or dithiodiglycol, or triol such as glycerine or hexane-1,2,6-triol; (C1 to C4) alkyl ether of polyhydric alcohol such as ethylene glycol monomethyl ether or ethylene glycol monoethyl ether, diethylene glycol monomethyl ether or diethylene glycol monoethyl ether, or triethylene glycol monomethyl ether or triethylene glycol monoethyl ether; γ-butyrolactone; or dimethylsulfoxide; and the like. These organic solvents may be used alone or in combination of two or more kinds.

Ink preparation agents to be used in preparation of the above ink composition include, for example, an antiseptic and fungicide, a pH adjuster, a chelating agent, a rust-preventive agent, a water-soluble UV absorbing agent, a water-soluble polymer compound, a dye dissolving agent, an antioxidant, a surfactant and the like. Hereinafter, these agents will be explained.

Specific examples of the fungicide include sodium dehydroacetate, sodium benzoate, sodium pyridinethion-1-oxide, ethyl p-hydroxybenzoate, 1,2-benzisothiazolin-3-one and a salt thereof. These are used preferably at 0.02 to 1.00% by weight in the ink composition.

Examples of the antiseptic agent include, for example, compounds such as organic sulfur compound, organic nitrogen and sulfur compound, organic halide, haloallylsulfone compound, iodopropargyl compound, N-haloalkylthio compound, nitrile compound, pyridine compound, 8-oxyquinoline compound, benzothiazole compound, isothiazoline compound, dithiol compound, pyridineoxide compound, nitropropane compound, organic tin compound, phenol compound, quaternary ammonium salt compound, triazine compound, thiazine compound, anilide compound, adamantane compound, dithiocarbamate compound, brominated indanone compound, benzyl bromoacetate compound, inorganic salt compound, and the like. A specific example of the organic halogen compound includes, for example, sodium pentachlorophenol; a specific example of the pyridineoxide compound includes, for example, sodium 2-pyridinethiol-1-oxide; a specific example of the inorganic salt compound includes, for example, anhydrous sodium acetate; and the isothiazoline compound includes, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride and the like. Specific examples of the other antiseptic and fungicides include sodium sorbate, sodium benzoate and the like.

As the pH adjuster, any substance can be used as long as it can control the pH of the ink, for example, in the range of 5 to 11 without adverse effects on the ink to be prepared. Its specific examples include, for example, an organic base such as alkanolamines such as diethanolamine, triethanolamine and N-methyldiethanolamine or potassium acetate; or an inorganic base such as alkali metal hydroxides such as lithium hydroxide, sodium hydroxide or potassium hydroxide, alkali metal carbonates such as lithium carbonate, sodium carbonate, sodium hydrogen carbonate and potassium carbonate, ammonium hydroxides (ammonia), and sodium silicate or disodium phosphate; and the like.

Specific examples of the chelating agent include, for example, sodium ethylenediaminetetraacetate, sodium nitrilotriacetate, sodium hydroxyethylethylenediamine triacetate, sodium diethylenetriaminepentaacetate, sodium uracildiacetate and the like.

Specific examples of the rust-preventive agent include, for example, hydrogen sulfite, sodium thiosulfate, ammonium thioglycollate, diisopropylammonium nitrite, pentaerythritol tetranitrate, dicyclohexylammonium nitrite and the like.

Examples of the water-soluble ultraviolet absorber include a sulfonated benzophenone compound, a benzotriazole compound, a salicylic acid compound, a cinnamic acid compound and a triazine compound.

Specific examples of the water-soluble polymer compound include, for example, polyvinyl alcohol, cellulose derivatives, polyamines, polyimines and the like.

Specific examples of the dye dissolving agent include, for example, ε-caprolactam, ethylene carbonate, urea and the like.

For examples of the antioxidant, for example, various organic and metal complex antifading agents can be used. Examples of the above organic antifading agent include hydroquinones, alkoxyphenols, dialkoxyphenols, phenols, anilines, amines, indanes, chromans, alkoxyanilines, heterocycles and the like.

Examples of the surfactant include, for example, known surfactants such as anion compound, cation compound and nonion compound. Examples of the anionic surfactant include alkyl sulfonate, alkyl carboxylate, α-olefin sulfonate, polyoxyethylene alkyl ether acetate, N-acylamino acid and a salt thereof, N-acylmethyltaurine salt, alkylsulfate polyoxyalkyl ether sulfate, alkyl sulfate polyoxyethylene alkyl ether phosphate, rosin acid soap, castor oil sulfate, lauryl alcohol sulfate, alkylphenol phosphate, alkyl phosphate, alkylallyl sulfonate, diethyl sulfosuccinate, diethylhexyl sulfosuccinate, dioctyl sulfosuccinate and the like. The cationic surfactant includes 2-vinyl pyridine derivatives, poly 4-vinyl pyridine derivatives and the like. Specific examples of the amphoteric surfactant include lauryl dimethyl amino acetic acid betaine, 2-alkyl-N-carboxymethyl-N-hydroxyethylimidazolinium betaine, coconut oil fatty acid amide propyl dimethylamino acetic acid betaine, polyoctylpolyaminoethylglycine and others such as imidazoline derivatives. Specific examples of the nonionic surfactant include ethers such as polyoxyethylene nonylphenyl ether, polyoxyethylene octylphenyl ether, polyoxyethylene dodecylphenyl ether, polyoxyethylene oleyl ether, polyoxyethylene lauryl ether and polyoxyethylene alkyl ether; esters such as polyoxyethylene oleic acid, polyoxyethylene oleate, polyoxyethylene distearate, sorbitan laurate, sorbitan monostearate, sorbitan monooleate, sorbitan sesquioleate, polyoxyethylene monooleate and polyoxyethylene stearate; acetylene glycols such as 2,4,7,9-tetramethyl-5-decyn-4,7-diol, 3,6-dimethyl-4-octyn-3,6-diol and 3,5-dimethyl-1-hexyn-3-ol (for example, trade names: Surfynol 104, 105, 82, 465, and Olfine STG, manufactured by Nissin Chemical Industry Co., Ltd.); and the like. These ink preparation agents are used alone or in mixture thereof.

The ink composition of the present invention can be obtained by mixing the above components in arbitrary order and by stirring. The resulting ink composition may be, if desired, filtered with a membrane filter or the like to remove impurities. In order to adjust black tone of the ink composition, other coloring matters having various hues, other than the azo compound represented by the formula (1) of the present invention, can be mixed. In that case, coloring matters of black having other hues, yellow, magenta, cyan and other colors can be used.

The ink composition of the present invention can be used in various applications, suitably for a water-based ink for writing, a water-based printing ink, an ink for information recording and the like, particularly preferably used as an ink for inkjet and suitably in an inkjet recording method of the present invention described later.

Next, the inkjet recording method of the present invention will be explained. The inkjet recording method of the present invention is characterized by using the above ink composition of the present invention to perform recording. In the inkjet recording method of the present invention, recording can be performed on image receiving materials by inkjet using an ink for inkjet containing the above ink composition. An ink nozzle and the like to be used on that occasion are not especially limited and can be selected appropriately according to the purpose. As a method for recording by inkjet, known methods for inkjet recording can be used, for example, an electric charge controlling method of discharging ink utilizing electrostatic induction force, a drop-on-demand method (pressure pulse method) of making use of vibration pressure of piezoelectric elements, an acoustic inkjet method of discharging ink by radiation pressure of acoustic beams to ink, where the acoustic beams are converted from electric signals, a thermal inkjet method (Bubble Jet (registered trademark)) of making use of pressure of bubbles generated by heating ink, and the like. The above inkjet recording method includes a method of injecting a number of tiny droplets of a low concentration ink called a photo ink, a method for improving image quality using multiple inks having substantially the same hue and different concentration, and a method of using a colorless and transparent ink.

The colored article of the present invention is an article colored with the above compound of the present invention or a aqueous composition containing it, preferably an ink composition. The colored article of the present invention is more preferably colored by an inkjet printer using the ink composition of the present invention. Articles to be colored include, for example, sheet for information transmission such as paper and film, textile and/or cloth (any material of cellulose, nylon and/or wool, and the like can be), leather, substrates for color filters and the like. As the sheet for information transmission, preferable are surface-treated ones, specifically ones provided with an ink receiving layer on the substrate of paper (including synthetic paper), film or the like. An ink receiving layer can be provided, for example, by impregnating or coating a cationic polymer on the above substrate, or by coating porous white inorganic substance such as porous silica, aluminasol, special ceramics and the like which can adsorb the coloring matter in the ink, on the surface of the above substrate, together with a hydrophilic polymer such as polyvinyl alcohol, polyvinyl pyrrolidone and the like. Such sheets as provided with an ink receiving layer are usually called inkjet paper (film), glossy paper (film) and the like, and available as commercial items such as, for example, Pictorico (trade name; manufactured by Asahi Glass Co., Ltd.), Professional Photopaper, Super Photopaper, and Matte Photopaper (all manufactured by Canon Inc.), PM Photograph Paper (glossy), PM Matte Paper (both are trade names; manufactured by Seiko-Epson Corporation), Premium Plus Photo Paper, Premium Glossy Film, Photo Paper (all are trade names; manufactured by Hewlett Packard Japan, Ltd.), PhotoLikeQP (trade name; manufactured by Konica Corporation) and the like. It goes without saying that a plain paper can be used.

It is known that discoloration or fading of images recorded on sheet for information transmission among them, the surface of which is coated with porous white inorganic substance, is especially to be proceeded by ozone gas, but the ink composition of the present invention is so superior in ozone gas fastness that it has an effect especially in recording on such a record-receiving material.

For recording on a record-receiving material such as sheet for information transmittance by the inkjet recording method of the present invention, for example, a container containing the above ink composition may be set on the predefined position of an inkjet printer and recording can be performed on a record-receiving material in a conventional manner. In the inkjet recording method of the present invention, the ink composition of the present invention of black can be used in combination with one or more accordingly selected from known ink compositions of magenta, cyan, yellow, and if required, green, blue (or violet), red (orange) and the like. Each color ink composition to be used in the combination is injected into each container, which is loaded in the predefined position in the inkjet printer for use, as well as a container containing a water-based black ink composition for inkjet recording of the present invention.

The azo compound of the present invention is excellent in water-solubility, and the ink composition of the present invention comprising this azo compound does not exhibit crystal precipitation, change in the physical property, color change nor the like after storage for a long period of time, and exhibit favorable storage stability. And a black ink composition for recording which contains the azo compound of the present invention is used for inkjet recording or for writing tools, and its printed images exhibit a black color with high printing density and are excellent in ozone gas fastness, light fastness and bronzing properties when recording is performed on a plain paper and an inkjet paper. In this connection, the term “excellent bronzing properties” described for the sake of simplicity in the description means that bronzing does not occurs or hardly occurs.

### EXAMPLES

Hereinafter, the present invention will be more specifically explained by Examples, but the present invention is not limited to the following Examples at all. In this connection, “part” and “%” in the specification are based on mass unless otherwise specified. In addition, a sulfone group is shown in free acid form in the following formulas.

### Example 1

(1) After 6.4 parts of 2-amino-5-naphthol-1,7-disulfonic acid and 4.1 parts of p-toluenesulfonylchloride were reacted in water at pH 8.0 to 8.5 and a temperature of 70° C. for 1 hour, the reaction solution was acidified and subjected to salting out, and the precipitate was separated by filtration to obtain a compound of the formula (12). In 90 parts of water, 8.8 parts of said compound obtained was dissolved, while adjusting the pH to 6.0 to 8.0 with a sodium carbonate. After 6.8 parts of 35% hydrochloric acid was added to the resulting solution which was then cooled to 0 to 5° C., 3.6 parts of 40% sodium nitrite aqueous solution was added thereto to diazotize the compound of the formula (12).

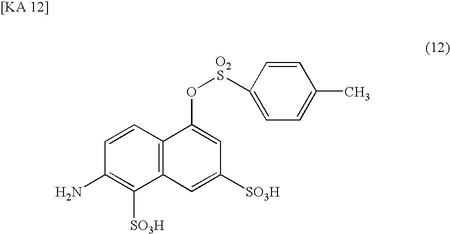

After a liquid where 5.8 parts of 4-amino-5-hydroxynaphthalene-1,7-disulfonic acid was suspended in 60 parts of water was added to this diazo suspension, the resulting suspension was stirred at 10 to 20° C. for 4 hours while maintaining the pH value at 2.4 to 2.8 with a sodium carbonate. Subsequently, the pH value of said liquid was adjusted to 7.0 to 8.5 with a sodium carbonate to dissolve the suspended matter, so as to obtain a solution containing a monoazo compound of the formula (13).

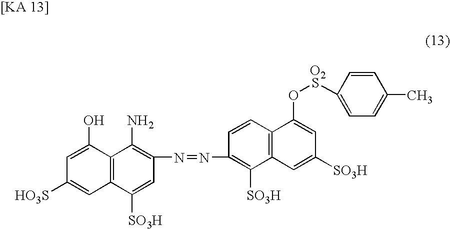

(2) In 50 parts of water, 5.2 parts of 4-nitroaniline-2-sodium sulfonate was dissolved, and 6.4 parts of 35% hydrochloric acid and 4.0 parts of 40% sodium nitrite aqueous solution were added thereto at 0 to 5° C. for diazotization. This diazo suspension was added dropwise in the above obtained solution containing the monoazo compound of formula (13) at 10 to 20° C. being the temperature of said solution, while maintaining the pH value of said solution at 8.0 to 9.0 with sodium carbonate. After completion of the dropwise addition, it was stirred at 15 to 30° C. and pH 8.0 to 9.0 for 2 hours to obtain a solution containing a disazo compound of the formula (14).

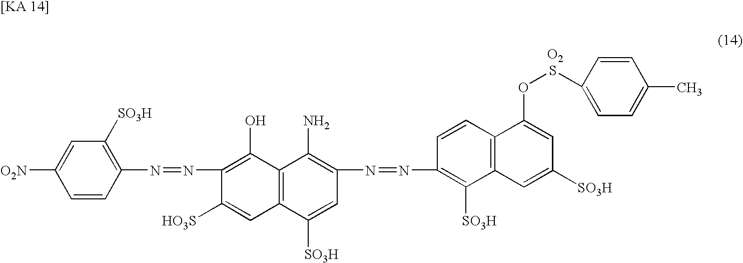

The above obtained solution was heated to 70° C., and then stirred for 1.5 hours while maintaining the pH value at 10.5 to 11.0 with a sodium hydroxide. After said solution was cooled to room temperature, the pH was adjusted to 7.0 to 8.0 by addition of 35% hydrochloric acid, the solution was then subjected to salting out by addition of a sodium chloride, and the precipitate was separated by filtration to obtain a wet cake containing a compound of the formula (15).

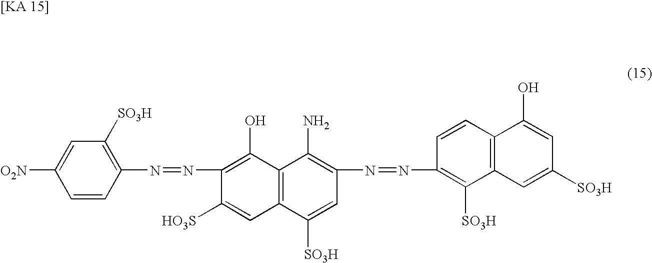

(3) In 100 parts of water, 10.9 parts of a compound of the following formula (16) obtained by the method described in JP 2005-068416 A (where the compound was obtained by adjusting the pH value to no more than 0.5 with 35% hydrochloric acid for aciding out from the reaction solution, and separated by filtration and drying) was dispersed, the pH of the dispersion was adjusted to 6.0 to 7.0 by addition of a sodium hydroxide to dissolve the dispersed matter, and 5.9 parts of 35% hydrochloric acid and 2.9 parts of 40% sodium nitrite aqueous solution were added to the resulting solution at 0 to 5° C. to diazotize the compound of the formula (16). The obtained diazo suspension was added dropwise to a solution where the wet cake containing the compound of the formula (15) obtained by the reaction in the above (2) was dissolved in 140 parts of water, at 15 to 30° C. being the temperature of said solution while maintaining the pH value of said solution at 8.0 to 9.0 with sodium carbonate. After completion of the dropwise addition, it was stirred at a temperature of 15 to 30° C. and pH 8.0 to 9.0 for 2 hours and then heated to 70° C., followed by stirring for 1.5 hours while maintaining the pH value at 10.5 to 11.0 with a sodium hydroxide.

After the resulting solution was cooled to room temperature, the pH was adjusted to 7.0 to 8.0 by addition of 35% hydrochloric acid, the solution was then subjected to salting out by addition of a sodium chloride, and the precipitate was separated by filtration.

The obtained wet cake was dissolved in 200 parts of water and then crystallized by addition of 300 parts of methanol, and the precipitate was separated by filtration. Further, the obtained wet cake was dissolved in 150 parts of water, and then crystallized by addition of 200 parts of 2-propanol, and the precipitate was separated by filtration and dried to obtain 16.0 parts of an azo compound (Compound No. 3 in Table 2) of the formula (17) of the present invention as a sodium salt.

The maximum absorption wavelength (λ max) of this compound in an aqueous solution of pH 7 to 8 was 626 nm and the solubility was not less than 100 g/L.

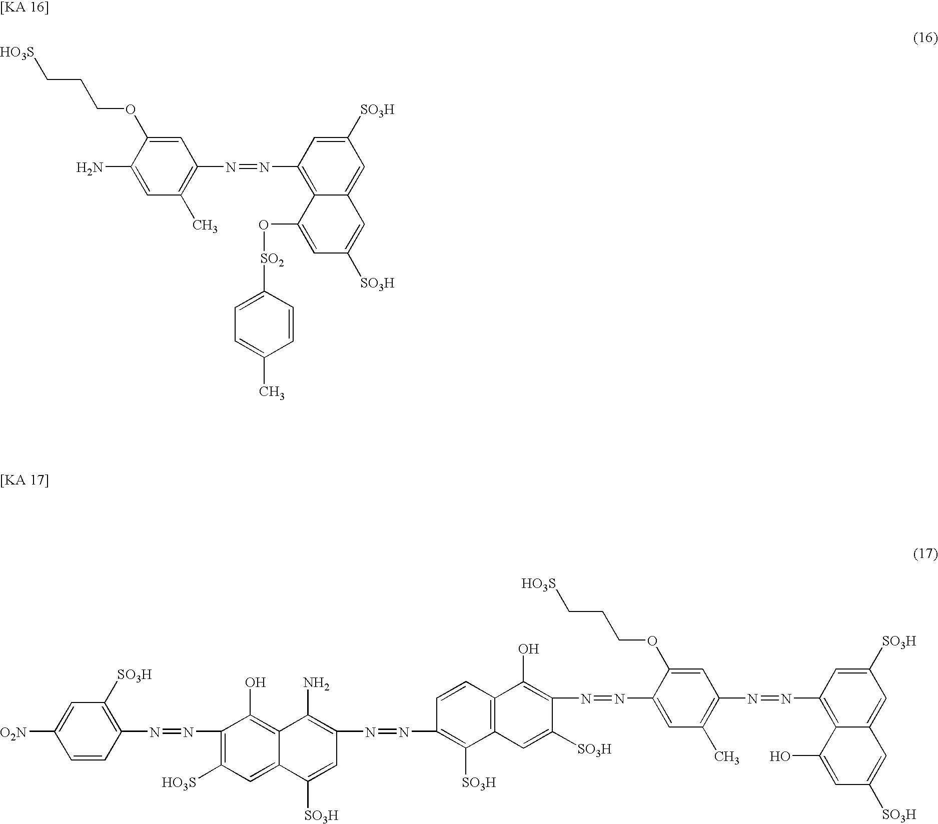

### Example 2

### (A) Preparation of Ink

An ink composition of the present invention of black was prepared by mixing the following components and foreign substances were removed by filtration with a 0.45 μm membrane filter.

And ion-exchanged water was used as water. In preparing the ink, the pH of ink was adjusted to pH 7 to 9 with an ammonium hydroxide and then ion-exchanged water was added so that the total amount of the ink was 100 parts.

TABLE 3

| | | |
|---|---|---|
| Compound obtained in the above Example 1 | 5.0 | parts |
| Glycerin | 5.0 | parts |
| Urea | 5.0 | parts |
| N-methyl-2-pyrrolidone | 4.0 | parts |
| Isopropyl alcohol | 3.0 | parts |
| Butyl carbitol | 2.0 | parts |
| Surfactant (Surfynol 105 manufactured by | 0.1 | part |
| Nissin Chemical Industry Co., Ltd.) | | |
| Water + ammonium hydroxide | 75.9 | parts |
| Total | 100.0 | parts |

In Table 3, “Compound obtained in the above Example 1” represents the compound of the formula (17). This water-based ink composition did not exhibit precipitation separation and its physical property was not changed, after storage thereof for a long period of time.

### (B) Inkjet Printing

Using the above obtained ink composition, by an inkjet printer (trade name: BJ-S630, manufactured by Canon Inc.), inkjet recording was conducted on two kinds of professional glossy paper (1. Professional Glossy Paper PR: Professional Photo Paper PR-101 (trade name) manufactured by Canon Inc., 2. Professional Glossy Paper PM: PM Photograph Paper (glossy) KA420PSK (trade name) manufactured by Seiko-Epson Corporation).

In printing, an image pattern was made so as to obtain several stages of gradations in reflection density, and a print in halftone black was obtained (As a grayscale mode is used in printing, any recording liquid of yellow, cyan, or magenta is not used in combination other than a black recording liquid). Using a calorimeter (SpectroEye manufactured by GRETAG-MACBETH), evaluation of light fastness test and ozone gas fastness test was conducted on the gradation portion where the reflection density D value of the print before testing was closest to 1.0.

### (C) Evaluation of Recorded Image

As for recorded images according to the water-based ink composition of the present invention, evaluation was conducted on change in density after light fastness test, and change in density after ozone gas fastness test. In this connection, the tests were conducted on Professional Glossy Paper PR and Professional Glossy Paper PM on which the above inkjet printing was performed. The results are shown in Table 4. The specific methods for the tests are described below.

### 1) Light Fastness Test

Using a xenon weatherometer (Ci4000 manufactured by ATLAS Electric Devices Co.), each sample, with a glass plate having a thickness of 2 mm set up so as to allow an air layer to be between the sample and the glass, was irradiated for 50 hours under the conditions of an illuminance of 0.36 W/m², a humidity of 60% RH and a temperature of 24° C. After completion of the tests, color measuring was conducted using the above calorimeter. Residual percentages of the coloring matters were calculated by (reflection density after the test/reflection density before the test)×100(%) to evaluate. Judgment was conducted by the following criteria.

∘ Residual percentage: no less than 95%

Δ Residual percentage: less than 95% and no less than 90%

x Residual percentage: less than 90%

### 2) Ozone Gas Fastness Test

Using a an ozone weatherometer (manufactured by Suga Test Instruments Co., Ltd.), each printed sample was left for 4 hours at an ozone concentration of 40 ppm, a humidity of 60% RH and a temperature of 24° C. After completion of the tests, color measuring was conducted using the above colorimeter. Residual percentages of the coloring matters were calculated by (reflection density after the test/reflection density before the test)×100(%) to evaluate. Judgment was conducted by the following criteria.

∘ Residual percentage: no less than 70%

Δ Residual percentage: no less than 60% and less than 70%

x Residual percentage: less than 60%

### Comparative Example 1

For comparison, an ink composition was prepared by the same composition of the ink as in Example 2 using the coloring matter of 1 in Table 1-1 of Patent Literature 1 (the following formula (18)) as a water-soluble coloring matter for inkjet. The evaluation results of printing density, light fastness, and ozone gas fastness of the obtained recorded images were shown in Table 4.

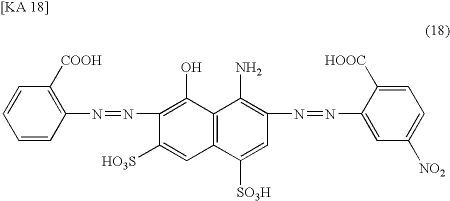

### Comparative Example 2

Similarly, for comparison, an ink composition was prepared by the same composition of the ink as in Example 2 using a coloring matter AN-250 described in Example 1 of Patent Literature 3 (the following formula (19)) as a water-soluble coloring matter for inkjet. The evaluation results of printing density, light fastness, and ozone gas fastness of the obtained recorded images were shown in Table 4.

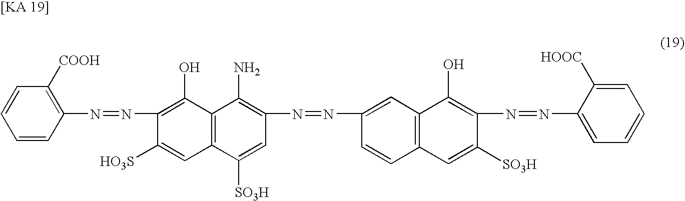

TABLE 4

| | |
|---|---|
| Light | Ozone gas |
| fastness | fastness |

Example 2 (Formula (17))

| | | |
|---|---|---|
| Professional Glossy Paper PR | ∘ | ∘ |
| Professional Glossy Paper PM | ∘ | ∘ |

Comparative Example 1 (Formula (18))

| | | |
|---|---|---|
| Professional Glossy Paper PR | Δ | x |
| Professional Glossy Paper PM | ∘ | Δ |

Comparative Example 2 (Formula (19))

| | | |
|---|---|---|
| Professional Glossy Paper PR | Δ | x |
| Professional Glossy Paper PM | ∘ | x |

As is cleared from Table 4, the images recorded with the ink composition containing the azo compound of the present invention exhibited the same or better light fastness compared with the images recorded with the conventional black dye (Comparative Example). And a clearer difference in ozone gas fastness was shown. That is, the both Professional Glossy Papers showed a residual percentage of coloring matter of no less than 70% in Example 2 of the present invention; Professional Glossy Paper PR showed a residual percentage of coloring matter of less than 60% and Professional Glossy Paper PM showed a residual percentage of coloring matter of no less than 60% and less than 70% in Comparative Example 1; in Comparative Example 2, the residual percentage of coloring matter was less than 60% even when any of the Glossy Papers were used. From this, it is found that ozone gas fastness of the images recorded with the azo compound of the present invention is extremely superior.

In addition, the azo compound of the present invention has high and stable solubility and makes it possible to design an ink having high density.

### INDUSTRIAL APPLICABILITY

The aqueous composition, especially the water-based ink composition, containing the azo compound of the present invention has good storage stability, and recorded articles with said ink composition have superior light fastness and ozone gas fastness, so said ink composition is suitably used as a black ink liquid for inkjet recording and/or writing tools.

1. An azo compound represented by the following Formula (1) 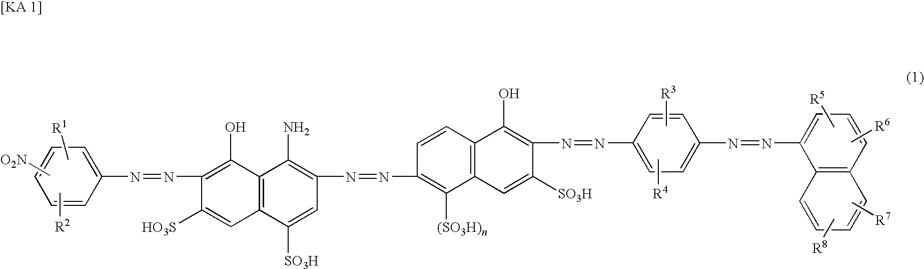
(wherein, each of R¹, and R² independently represents a hydrogen atom, a halogen atom, a cyano group, a carboxy group, a sulfo group, a sulfamoyl group, an N-alkylaminosulfonyl group, an N-phenylaminosulfonyl group, a (C1 to C4) alkylsulfonyl group which may be substituted by a hydroxy group, a phosphono group, a nitro group, an acyl group, a ureide group, a (C1 to C4) alkyl group (which may be substituted by a group selected from the group consisting of a hydroxy group and a (C1 to C4) alkoxy group), a (C1 to C4) alkoxy group (which may be substituted by a group selected from the group consisting of a hydroxy group, a (C1 to C4) alkoxy group, a sulfo group and a carboxy group), an acylamino group, an alkylsulfonylamino group or a phenylsulfonylamino group (the phenyl group may be substituted by a group selected from the group consisting of a halogen atom, an alkyl group and a nitro group),
each of R³, R⁴, R⁵, R⁶, R⁷ and R⁸ independently represents a hydrogen atom, a halogen atom, a hydroxy group, a cyano group, a carboxy group, a sulfo group, a sulfamoyl group, an N-alkylaminosulfonyl group, an N-phenylaminosulfonyl group, a (C1 to C4) alkylsulfonyl group which may be substituted by a hydroxy group, a phosphono group, a nitro group, an acyl group, a ureide group, a (C1 to C4) alkyl, group (which may be substituted by a hydroxy group or a (C1 to C4) alkoxy group), a (C1 to C4) alkoxy group (which may be substituted by a hydroxy group, a (C1 to C4) alkoxy group, a sulfo group or a carboxy group), an acylamino group, an alkylsulfonylamino group or a phenylsulfonylamino group (the phenyl group may be substituted by a halogen atom, an alkyl group or a nitro group), and
n represents 0 or 1, respectively)
or a salt thereof.

2. The azo compound or the salt thereof according to claim 1, wherein R¹ is a sulfo group or a carboxy group, the substitution position of the nitro group is the para-position to the azo group when the substitution position of R¹ is the ortho-position to the azo group, the substitution position of the nitro group is the ortho-position to the azo group when the substitution position of R¹ is the para-position to the azo group, and R² is a hydrogen atom.

3. The azo compound or the salt thereof according to claim 1, wherein R¹ is a sulfo group and its substitution position is the ortho-position to the azo group, the substitution position of the nitro group is the para-position to the azo group, R² is a hydrogen atom, and n is 1.

4. The azo compound or the salt thereof according to claim 1, wherein R⁶ and R⁷ are sulfo groups.

5. The azo compound or the salt thereof according to claim 1, wherein R⁵ is a hydrogen atom, R⁶ and R⁷ are sulfo groups, and R⁸ is a hydroxy group.

6. The azo compound or the salt thereof according to claim 1, wherein R¹ is a sulfo group or a carboxy group, R² is a hydrogen atom, R³ is a group selected from the group consisting of a 3-sulfopropoxy group, a carboxymethoxy group, a sulfo group, and a 2-hydroxyethoxy group, R⁴ is a group selected from the group consisting of a methyl group, an acetylamino group, a hydrogen atom, a 2-hydroxyethoxy group and a sulfo group, R⁵ is a group selected from the group consisting of a hydrogen atom, a toluenesulfonyl amino group and a sulfo group, R⁷ is a hydrogen atom or a sulfo group, each of R⁶ and R⁸ independently is a sulfo group or a hydroxy group, and n is 1.

7. The azo compound or the salt thereof according to claim 1, wherein R¹ is a sulfo group and its substitution position is the ortho-position to the azo group, the substitution position of the nitro group is the para-position to the azo group, R² is a hydrogen atom, R⁵ is a hydrogen atom, R⁶ and R⁷ are sulfo groups, R⁸ is a hydroxy group and its substitution position is the peri-position to the azo group, and n is 1.

8. The azo compound or the salt thereof according to claim 1, wherein R¹ is a sulfo group and its substitution position is the ortho-position to the azo group, the substitution position of the nitro group is the para-position to the azo group, R² is a hydrogen atom, R³ is a 3-sulfopropoxy group, R⁴ is a methyl group, R⁵ is a hydrogen atom, R⁶ and R⁷ are sulfo groups, R⁸ is a hydroxy group and its substitution position is the peri-position to the azo group, and n is 1.

9. An ink composition characterized by comprising at least one of the azo compounds or the salts thereof according to any one of claims 1 to 8.

10. An inkjet print recording method wherein ink drop jets of an ink composition comprising the azo compound or salts thereof according to claim 1 are generated and deposited onto record-receiving materials.

11. The inkjet print recording method according to claim 10, wherein a record-receiving material in the inkjet print recording method is an information transmission sheet.

12. The inkjet print recording method according to claim 11, wherein the information transmission sheet contains a porous white inorganic substance.

13. An ink jet printer loading a container containing the ink composition according to claim 9.

14. A colored article colored with the azo compound or the salt thereof according to any one of claims 1 to 8.

15. The azo compound or the salt thereof according to claim 1, wherein R³ is a hydroxy (C1 to C4) alkoxy group, a sulfo (C1 to C4) alkoxy group, a carboxy (C1 to C4) alkoxy group or a sulfo group, R⁴ is a hydrogen atom, a hydroxy (C1 to C4) alkoxy group, a sulfo group, (C1 to C4) alkyl group or a (C1 to C4) acylamino group, R⁵ is a hydrogen atom or a phenylsulfonylamino group substituted by a (C1 to C4) alkyl group, R⁶ and R⁷ are sulfo groups, and R⁸ is a hydrogen atom, a hydroxy group or a sulfo group.
